(19) United States
(12) Patent Application Publication
(10) Pub. No.: US 2014/0078026 A1
(43) Pub. Date: Mar. 20, 2014

(54) Arranged Structure for Common Jig Implemention of Two Kinds of Display Panels and the Method Thereof

(71) Applicants: Peng Du, Shenzhen City (CN); Jiali Jiang, Shenzhen City (CN)

(72) Inventors: Peng Du, Shenzhen City (CN); Jiali Jiang, Shenzhen City (CN)

(73) Assignee: SHENZHEN CHINA STAR OPTOELECTRONICS TECHNOLOGY CO., LTD., Shenzhen, Guangdong (CN)

(21) Appl. No.: 13/642,533

(22) PCT Filed: Sep. 21, 2012
(86) PCT No.: PCT/CN2012/081738

§ 371 Date: Oct. 21, 2012

(30) Foreign Application Priority Data
Sep. 19, 2012 (CN) 201210349099.7

(51) Int. Cl. G09G 3/20

(52) U.S. Cl. 345/55

(57) ABSTRACT

An arranged structure for common jig implementation of two kinds of display panels is disclosed. When arranging on the glass substrates, first-sized displays and second-sized displays respectively include a plurality of connecting pad groups connected with the display panels. Each of the connecting pad groups include n number of connecting pads. The width of each of the connecting pads is d, and a distance between two adjacent connecting pads in a same connecting pad groups is p. A distance between two adjacent first-sized display panels is L1, and a distance between two adjacent connecting pad groups of the first-sized display panels is L3. A distance between the two adjacent second-sized display panels is L2, and a distance between two adjacent connecting pad groups of the second-sized display panels is L4. The n, d, p, L1, L2, L3, and L4 satisfy the equation: L3=L4, p=|L1−L2|, (n−1)*p+d<L3. With the arranged structure, the display panels of two sizes may share the jigs.

### BACKGROUND OF THE INVENTION

1. Field of the Invention

Embodiments of the present disclosure relate to display technology, and more particularly to an arranged structure for common jig implementing of two kinds of display panels and the method thereof.

2. Discussion of the Related Art

Curing alignment machines and testing machines are two important jigs tier TFT-LCD manufacturing processes. When Ultraviolet Curing (UV) process is applied to the display panel, the coring alignment machine provides alignment voltage to the display panel to steer the liquid crystals so as to complete the alignment. When testing process is applied to the display panel, the testing machines is for testing if the signals of the display panels are correctly transmitted or displayed.

When the above two jig operates, the display panels have to be arranged on the glass substrate, and the arranged glass substrate has to be uploaded to the jig so that probes of the jig may contact with the connecting pad of display panels. Finally, the glass substrates are moved in the same direction to complete the whole process. For display panels with different sizes, using common jig may reduce the cost. However, the limitation of conventional jig regarding how to arrange the display panels on the glass substrate is very strict, i.e., the distance between the display panels have to be the same.

Therefore, there is a need to provide an arranged structure for common jig implementation of two kinds of display panels and the method thereof.

### SUMMARY

The object of the claimed invention is to provide an arranged structure for common jig implementation of two kinds of display panels and the method thereof so that the jigs may be used by two kinds of display panels of different sizes.

In one aspect, an arranged structure for common jig implementation of two kinds of display panels includes a plurality of first-sized display panels, and a same number of a plurality of second-sized display panels as the plurality of first-sized display panels. Wherein each of the first-sized display panels and second-sized display panels are disposed on the glass substrate. Wherein each of the first-sized display panels and second-sized display panels respectively includes a plurality of connecting pad groups connected with the first-sized and second-sized display panels. Each of the connecting pad groups includes n number of connecting pads. The width of each of the connecting pads is d, and a distance between two adjacent connecting pads in a same connecting, pad groups is p. A distance between two adjacent first-sized display panels is L1, and a distance between two adjacent connecting pad groups of the first-sized display panels is L3. A distance between the two adjacent second-sized display panels is L2, and a distance between two adjacent connecting pad groups of the second-sized display panels is L4. Wherein, the n, d, p, L1, L2, L3, and L4 satisfy the equation: L3=L4, p=|L1−L2|, (n−1)*p+d<L3.

Wherein each kind of the display panels includes a display area, a route area surrounding the display area, a plurality of contact pads arranged within the route area, and the connecting pad groups are disposed in an outer side of the display panels and electrically connect with the plurality of contact pads.

Wherein the connecting pad groups are arranged in two rows, and the two rows are symmetrically arranged in an up and down side of display panels, and each of the connecting pad groups includes four connecting pads.

Wherein the contact pads includes odd scanning line contact pads electrically connects with odd scanning lines of the display panel; even scanning line contact pads electrically connects with odd scanning lines of the display panel; red data line contact pads electrically connects with red data lines of the display panel; green data line contact pads electrically connects with green data lines of the display panel; blue data line contact pads electrically connects with blue data lines of the display panel; array common electrode contact pads electrically connects with array common electrode of the display panel; and CF common electrode contact pads electrically connects with CF common electrode of the display panel.

Wherein the connecting pad groups includes odd scanning line connecting pad groups electrically connect with the odd scanning line contact pads; even scanning line connecting pad groups electrically connect with the even scanning line contact pads; red data line connecting pad groups electrically connect with the red data line contact pads; green data line connecting pad groups electrically connect with the green data line contact pads; the blue data line connecting pad groups electrically connect with the blue data line contact pads; the array common electrode connecting pad groups electrically connect with the array common electrode connecting pads; and CF common electrode connecting pad groups electrically connect with the CF common electrode contact pads.

In another aspect, a method of common jig implementation for two kinds of display panels including the following steps: arranging a plurality of first-sized display panels on a glass substrate; arranging a same number of a plurality of a second-sized display panels as the plurality of first-sized display panels on the glass substrate; uploading the arranged glass substrate to the jig; wherein, each of the first-sized display panels and second-sized display panels display panel respectively includes a plurality or connecting pad groups connected with the first-sized and second-sized display panels, each of the connecting pad group includes n number of connecting pads, the width of each of the connecting pads is d, and distance between two adjacent connecting pad in a same connecting pad groups is p; wherein when the first-sized display panels are arranged, a distance between two adjacent first-sized display panels is L1, and a distance between two adjacent connecting pad groups of the first-sized display panels is L3; when the second-sized display panels are arranged, a distance between the two adjacent second-sized display panels is L2, and a distance between two adjacent connecting pad groups of the second-sized display panels is L4; and wherein the n, d, p, L1, L2, L3, and L4 satisfy the equation: L3=L4, p=|L1−L2|, (n−1)*p+d<L3.

Wherein each of the display panels includes a display area, a route area surrounded the display area, a plurality of contact pads arranged within the route area, the connecting pad groups are disposed in an outer side of the display panels and are electrically connected with the plurality of contact pads.

Wherein the contact pads includes odd scanning line contact pads electrically connects with odd scanning lines of the display panel; even scanning line contact pads electrically connects with odd scanning lines of the display panel; red data line contact pads electrically connects with red data lines of the display panel; green data line contact pads electrically connects with green data lines of the display panel; blue data line contact pads electrically connects with blue data lines of the display panel; array common electrode contact pads electrically connects with array common electrode of the display panel; and CF common electrode contact pads electrically connects with CF common electrode of the display panel.

Wherein the connecting pad groups includes odd scanning line connecting pad group electrically connect with the odd scanning line contact pads; even scanning line connecting pad group electrically connect with the even scanning line contact pads; red data line connecting pad group electrically connect with the red data line contact pads; green data line connecting pad group electrically connect with the green data line contact pads; the blue data line connecting pad group electrically connect with the blue data line contact pads; the array common electrode connecting pad group electrically connect with the array common electrode connecting pads; and CF common electrode connecting pad group electrically connect with the CF common electrode contact pads.

Wherein two connecting pad groups are symmetrically arranged in an up and down side of display panels, and each of the connecting pad groups includes four connecting pads.

Wherein the jig is a curing alignment machine or a testing machine, and the jig includes a plurality of probes corresponding to the connecting, pad group of the display panels.

Wherein the uploading step further includes arranging, the first glass substrate by disposing the plurality of first-sized display panels and the corresponding connecting pad group; arranging the second glass substrate by disposing the plurality of second-sized display panels and the corresponding connecting pad group; and uploading the arranged first-sized glass substrate and the second-sized glass substrate to the jig.

By designing, the arranged structure on the glass substrate, the two kinds of display panels of different sizes may share the jig only if the number of the display panels for the two kinds of display panels are the same. In addition, the distance between the two kinds of display panels may be different. Thus, there is no limitation regarding the distance between the two kinds of display panels and the curing alignment machine and the testing machine may be shared among display panels of different sizes.

### BRIEF DESCRIPTION OF TILE DRAWINGS

FIG. 1 is a schematic view of the arranged structure of the common jig in accordance with one embodiment of the claimed invention.

FIG. 2 is a schematic view of the arranged structure on the glass substrate in accordance with one embodiment of the claimed invention.

FIG. 3 is a flowchart illustrating the method of implementing the arranged structure for the common jig of two kinds of display panels.

FIG. 4 is a schematic view showing the process of uploading the glass substrate to the jig.

### DETAILED DESCRIPTION OF THE EMBODIMENTS

Embodiments of the invention will now be described more fully hereinafter with reference to the accompanying drawings, in which embodiments of the invention are shown.

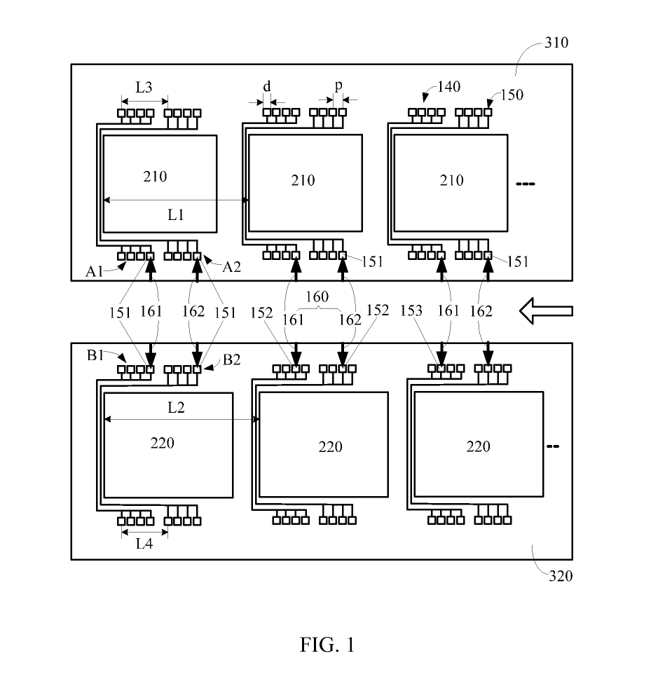

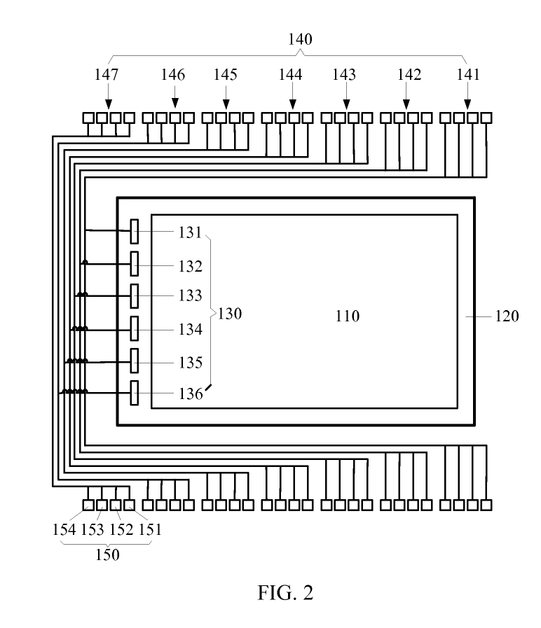

FIG. 1 is a schematic view of the arranged structure of the common jig in accordance with one embodiment of the claimed invention. As shown in FIG. 1, in the embodiment, a plurality of first-sized display panels 210 are disposed on a first glass substrate 310, and a same number of a plurality of second-sized display panels 220 as the plurality of first-sized panels 210 are disposed on a second glass substrate 320. In addition, the first-sized display panels 210 and the second-sized display panels 220 adopt the arranged structure of FIG. 2.

As shown in FIG. 2, the arranged structure on the glass substrate includes a display area 110, a route area 120, a plurality of contact pads 130, and a connecting pad group 140.

The contact pads 130 are arranged within the route area 120 of the display panel. The contact pads 130 includes odd scanning line contact pads 131 electrically connecting with odd scanning lines within the display area 110, even scanning line contact pads 132 electrically connecting with odd scanning lines within the display area 110, red data line contact pads 133 electrically connecting with red data lines within the display area 110, green data line contact pads 134 electrically connecting with green data lines within the display area 110, blue data line contact pads 135 electrically connecting with blue data lines within the display area 110, array common electrode contact pads 136 electrically connecting with array common electrode within the display area 110, and CF common electrode contact pads (not shown) electrically connecting with CF common electrode within the display area 110. The odd scanning line contact pads 131, the even scanning line contact pads 132, the red data line contact pads 133 the green data line contact pads 134, the blue data line contact pads 135, and the array common electrode connecting pads 136 are arranged on the array substrate of the display panels. The CF common electrode contact pads are arranged on the color filter substrate of the display panel.

The connecting pad groups 140 are disposed in an outer side of the display panels. Specifically, the connecting pad groups 140 are arranged in two rows, and the two rows are symmetrically arranged in an up and down side of the route area 120 of the display panels. In the embodiment, the connecting pad groups 140 includes odd scanning line connecting pad groups 141, even scanning line connecting pad groups 142, red data line connecting pad groups 143, green data line connecting pad groups 144, blue data line connecting pad groups 145, array common electrode connecting pad group 146, and CF common electrode connecting pad groups 147.

Each connecting pad groups 140 includes a plurality of connecting pads 150. In the embodiment, each connecting pad groups 140 preferably has four connecting pads including as first connecting pad 151, a second connecting pad 152, a third connecting pad 153, and a fourth connecting pad 154.

The connecting pad groups 140 electrically connect with corresponding contact pads 130. Specifically, the odd scanning line connecting pad groups 141 electrically connect with the odd scanning line contact pads 131. The even scanning line connecting pad groups 142 electrically connect with the even scanning line contact pads 132. The red data line connecting pad groups 143 electrically connect with the red data line contact pads 133. The green data line connecting pad groups 144 electrically connect with the green data line contact pads 134. The blue data line connecting pad groups 145 electrically connect with the blue data line contact pads 135. The array common electrode connecting pad groups 146 electrically connect with the array common electrode contact pads 136, the CF common electrode connecting pad groups 147 electrically connect with the CF common electrode contact pads.

In the embodiment, as shown in FIG. 1, each of the connecting pad groups 140 of the first-sized display panels 210 and the second-sized display panels 220 includes n number of connecting pads 150. The width of each of the connecting, pads 150 is d, and a distance between two adjacent connecting pads 150 in the same connecting pad group 140 is p.

When a plurality of the first-sized display panels 210 are arranged on the first glass substrate 310, a distance between two adjacent first-sized display panels 210 is L1, and a distance between two adjacent connecting pad groups 140 of the first-sized display panels 210 is L3.

When a plurality of the second-sized display panels 220 are arranged on the second glass substrate 320, a distance between two adjacent second-sized display panels 220 is L2, and a distance between two adjacent connecting pad groups 140 of the second-sized display panels 220 is L4.

The n, d, p, L1, L2, L3, and L4 satisfy the Equation 1 below;

L3=L4, p=|L1−L2|, (n−1)*p+d<L3

It is to be noted that the values of the variable n, d, p, L1, L2, L3, and L4 may be adjusted in accordance with real scenarios.

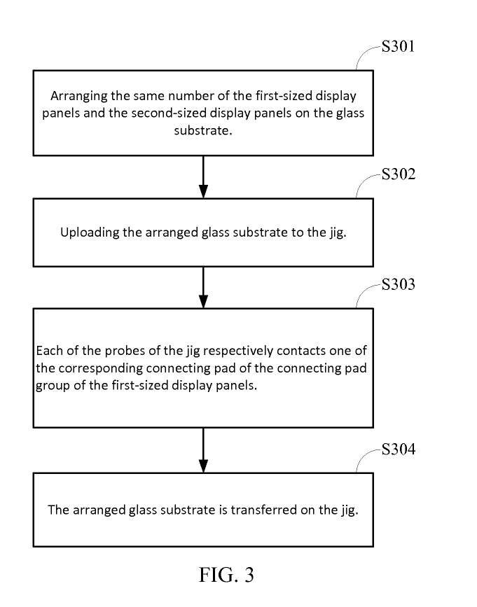

FIG. 3 is a flowchart illustrating the method of common jig implementation for the first-sized display panels 210 and the second-sized display panels 220.

As shown in FIG. 3, the method includes the following steps. In step S301, the same number of the first-sized display panels and the second-sized display panels are disposed on the glass substrate. The arranged structure of the first-sized display panels and the second-sized display panels satisfies the equation below:

L3=L4, p=|L1−L2|, (n−1)*p+d<L3

It is to be noted that the first-sized display panels and the second-sized display panels may be arranged on the same glass substrate or on different glass substrates. For example, the first-sized display panels are arranged on the first glass substrate and the second-sized display panels are arranged on the second glass substrate.

In step S302, the arranged glass substrate is uploaded to the jig.

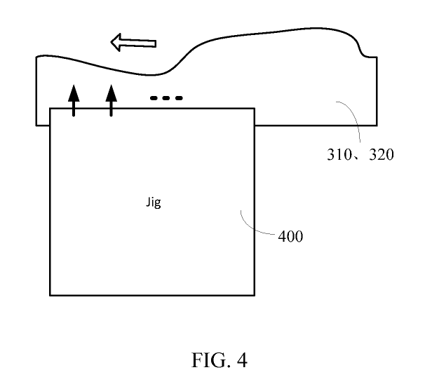

FIG. 4 is a schematic view showing the process of uploading the glass substrate to the jig. As shown in FIG. 4, in the embodiment, the jig 400 may be a curing alignment machine or a testing machine. Referring to FIG. 1, each of the jig 400 includes a plurality of probes corresponding to the connecting pad groups 140 of the first-sized display panels 210 and the second-sized display panels 220. Preferably, the jig 400 includes seven probes 160 corresponding to seven different connecting pad groups 140 of the first-sized display panels 210 and the second-sized display panels 220.

When the curing alignment machine conducts the alignment process to the first-sized display panels 210 and the second-sized display panels 220, the probes 160 provide the alignment voltage to the liquid crystal. When the first-sized display panels 210 and the second-sized display panels 220 are in the testing process executed by the testing machine, the probes 160 provide testing signals to the scanning, lines, the data lines, and pixel units of the first-sized display panels 210 and the second-sized display panels 220.

In step S303, the probes of the jig respectively contacts with the connecting pads of the first-sized display panels. As such, each of the probes respectively contacts one of the corresponding connecting pad of the connecting pad group of the first-sized display panels.

In step S304, after the locations of the probes are fixed, the arranged glass substrate is transferred on the jig.

Specifically, when the glass substrate is transferred on the jig, for the first-sized display panel, each of the probes contacts with one corresponding connecting pad of the connecting pad group receiving, the same kind of signals with the probes.

On the other hand, when the arranged glass substrate is transferred on the jig, for the second-sized display panels, the locations of the corresponding connecting pad for receiving the same kind of signals with the probes are different. It is understood that the probes contact with the second-sized display panels in turn along the transfer direction of the glass substrate.

The method of common jig implementation for the first-sized display panels and the second-sized display panels will now be described more fully hereinafter with reference to FIGS. 1, 3 and 4.

Specifically, the first-sized display panels 210 are arranged according to the structure as shown in FIG. 1. The arranged first-sized display panels 310 and second-sized display panels 320 are then uploaded to the jig 400 by transportation devices. The transportation devices may be conveyor belts or by manual processes.

As the number of the probes are the same with the number of the corresponding connecting pad groups 140 of each of the display panels, the probe 160 are respectively arranged in accordance with the connecting pad groups 140 of the first-sized display panels 210. Referring to FIG. 1, two out of seven connecting pads are taken as examples to illustrate the methods. One of the connecting pad of the connecting pad group is selected, such as the rightmost first connecting pad 151 contacts with the probe 160, and the locations of the probes 160 are fixed. The probes 160 are fixed fir the reason that the distance between two probes are fixed, and thus the jig may be shared. It is to be noted that the rightmost first connecting pad 151 is selected to contribute the convenience of the testing process. In other embodiment, any of the connecting pads 152, 153, 154 of the connecting, pad group 140 may be selected to connect with the probe 160.

After the locations of the probes 160 of the jig 400 are fixed, the first glass substrate 310 is transferred along the horizontal direction indicated by the arrow as shown in FIG. 1. The probes 160 contacts with the same connecting pads 150, such as the first connecting pad 151, of the connecting, pad group 140 of the first-sized display panels 210 all the time so as to provide the alignment voltage or the testing signals to the connecting pad groups 140.

After the locations of the probes 160 of the jig 400 are fixed, the second glass substrate 320 is transferred along the horizontal direction indicated by the arrow as shown in FIG. 1. As described above, as Equation 1 is satisfied, the probes 160 may contact with the corresponding connecting pads 150 of the connecting pad groups 140 of the second-sized display panels 220 to provide the alignment voltage or the testing signals to the connecting pad groups 140. However, the probes providing the same signals for two adjacent display panels contact with different connecting pads 150.

Specifically, the probes 160 contact with different connecting pads 150 of two adjacent second-sized display panels 220 when the second glass substrate 320 is transferred along the horizontal direction in turn.

For example, as shown in FIG. 1, the probe 161 is for providing the first data signal, and the probe 162 is for providing the second data signal. When the second-sized display panels 220 is transferred along the horizontal direction as indicated by the arrow, the probe 161 contacts with the first connecting pad 151 of the first connecting pad group B1 of the second-sized display panels 220, and the probe 162 contacts with the first connecting pad 151 of the second connecting pad group B2 of the second-sized display panels 220. At this time, the probe 161 contacts with the first connecting, pad 151 of the first connecting, pad group A1 of the first-sized display panels 210, and the probe 162 contacts the first connecting pad 151 of the second connecting pad group A2 of the first-sized display panels 210.

The probe 161 contacts with the second connecting pad 152 of the first connecting, pad group B1 of the second-sized display panels 220, and the probe 162 contacts the second connecting pad 152 of the second connecting pad group B2 of the first-sized display panels 210. At this time, the probe 161 still contacts with the first connecting pad 151 of the first connecting pad group A1 of the first-sized display panels 210, and the probe 162 still contacts with the first connecting pad 151 of the second connecting pad group A2 of the first-sized display panels 210.

The probe 161 contacts with the third connecting pad 153 of the first connecting pad group B1 of the second-sized display panels 220, and the probe 162 contacts with the third connecting pad 153 of the second connecting pad group B2 of the second-sized display panels 220. At this time, the probe 161 still contacts with the first connecting pad 151 of first connecting pad group A1 of the first-sized display panels 210, and the probe 162 still contacts with the first connecting pad 151 of the second connecting pad group A2 of the first-sized display panels 210.

Similarly, the probes 160 contact with different corresponding connecting pad 150 of two adjacent display panels 220, and the probes 160 contact with the second-sized display panels in turn along the transfer direction of the glass substrate.

It is to be noted that jig may be shared by the first-sized display panels 210 and the second-sized display panels 220 on the same glass substrate by adopting double-rows probes 160.

In view of the above, by providing the arranged structure for the display panels of two different sizes on the glass substrate, the two display panels may share the jig. The distance between the two display panels may be different so that there is no limitation regarding the distance between the display panels for the arranged structure. As such, the curing alignment machine and the testing machine may also be shared at the same time.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An arranged structure for common jig implementation of two kinds of display panels, comprising:
a plurality of first-sized display panels; and
a same number of a plurality of second-sized display panels as the plurality of first-sized display panels, wherein each of the first-sized display panels and second-sized display panels are disposed on the glass substrate, wherein each of the first-sized display panels and second-sized display panels respectively comprises a plurality of connecting pad groups connected with the first-sized and second-sized display panels, each of the connecting pad groups comprises n number of connecting pads, the width of each of the connecting pads is d, and as distance between two adjacent connecting pads in a same connecting pad groups is p;
a distance between two adjacent first-sized display panels is L1, and a distance between two adjacent connecting pad groups of the first-sized display panels is L3;
a distance between the two adjacent second-sized display panels is L2, and a distance between two adjacent connecting pad groups of the second-sized display panels is L4; and
wherein, the n, d, p, L1, L2, L3, and L4 satisfy the equation:
L3=L4, p=|L1−L2|, (n−1)*p+d<L3.

2. The arranged structure as claimed in claim 1, wherein each kind of the display panels comprises a display area, a route area surrounding the display area, a plurality of contact pads arranged within the route area, the connecting pad groups are disposed in an outer side of the display panels and electrically connect with the plurality of contact pads.

3. The arranged structure as claimed in claim 2, wherein the connecting pad groups are arranged in two rows, and the two rows are symmetrically arranged in an up and down side of the display panels, and each of the connecting pad groups comprises four connecting pads.

4. The arranged structure as claimed in claim 2, wherein the contact pads comprises:
odd scanning line contact pads electrically connects with odd scanning lines of the display panel;
even scanning line contact pads electrically connects with odd scanning lines of the display panel;
red data line contact pads electrically connects with red data lines of the display panel;
green data line contact pads electrically connects with green data lines of the display panel;
blue data line contact pads electrically connects with blue data lines of the display panel;
array common electrode contact pads electrically connects with array common electrode of the display panel; and
CF common electrode contact pads electrically connects with CF common electrode of the display panel.

5. The arranged structure as claimed in claim 4, wherein the connecting pad groups comprises:
odd scanning line connecting pad groups electrically connect with the odd scanning line contact pads;
even scanning line connecting pad groups electrically connect with the even scanning line contact pads;
red data line connecting pad groups electrically connect with the red data line contact pads;
green data line connecting pad groups electrically connect with the green data line contact pads;
the blue data line connecting pad groups electrically connect with the blue data line contact pads;
the array common electrode connecting pad groups electrically connect with the array common electrode connecting pads; and
CF common electrode contact pad groups electrically connect with the CF common electrode contact pads.

6. A method of common jig implementation for two kinds of display panels, comprising:
arranging a plurality of first-sized display panels on a glass substrate;
arranging a same number of a plurality of a second-sized display panels as the plurality of first-sized display panels on the glass substrate;
uploading the arranged glass substrate to the jig;
wherein, each of the first-sized display panels and second-sized display panels display panel respectively comprises a plurality of connecting pad groups connected with the first-sized and second-sized display panels, each of the connecting pad group comprises n number of connecting pads, the width of each of the connecting pads is d, and distance between two adjacent connecting pad in a same connecting pad groups is p;
wherein when the first-sized display panels are arranged, a distance between two adjacent first-sized display panels is L1, and a distance between two adjacent connecting pad groups of the first-sized display panels is L3;
when the second-sized display panels are arranged, a distance between the two adjacent second-sized display panels is L2, and a distance between two adjacent connecting pad groups of the second-sized display panels is L4; and
wherein, the n, d, p, L1, L2, L3, and L4 satisfy the equation:
L3=L4, p=|L1−L2|, (n−1)*p+d<L3.

7. The method of common jig implementation as claimed in claim 6, wherein each of the display panels comprises a display area, a route area surrounded the display area, a plurality of contact pads arranged within the route area, the connecting pad groups are disposed in an outer side of the display panels and are electrically connected with the plurality of contact pads.

8. The method of common jig implementation as claimed in claim 7, wherein the contact pads comprises:
odd scanning line contact pads electrically connects with odd scanning lines of the display panel;
even scanning line contact pads electrically connects with odd scanning lines of the display panel;
red data line contact pads electrically connects with red data lines of the display panel;
green data line contact pads electrically connects with green data lines of the display panel;
blue data line contact pads electrically connects with blue data lines of the display panel;
array common electrode contact pads electrically connects with array common electrode of the display panel; and
CF common electrode contact pads electrically connects with CF common electrode of the display panel.

9. The method of common jig implementation as claimed in claim 7, wherein the connecting pad groups comprises:
odd scanning line connecting pad group electrically connect with the odd scanning line contact pads;
even scanning line connecting pad group electrically connect with the even scanning line contact pads;
red data line connecting pad group electrically connect with the red data line contact pads;
green data line connecting pad group electrically connect with the green data line contact pads;
the blue data line connecting pad group electrically connect with the blue data line contact pads;
the array common electrode connecting pad group electrically connect with the array common electrode connecting pads; and
CF common electrode connecting pad group electrically connect with the CF common electrode contact pads.

10. The method of common jig implementation as claimed in claim 7, wherein two connecting pad groups are symmetrically arranged in an up and down side of display panels, and each of the connecting pad groups comprises four connecting pads.

11. The method of common jig implementation as claimed in claim 6, wherein the jig is a curing alignment machine or a testing machine, and the jig comprises as plurality of probes corresponding to the connecting pad group of the display panels.

12. The method of common jig implementation as claimed in claim 6, wherein the uploading step further comprises:
arranging the first glass substrate by disposing the plurality of first-sized display panels and the corresponding connecting pad group;
arranging the second glass substrate by disposing the plurality of second-sized display panels and the corresponding connecting pad group; and
uploading the arranged first-sized glass substrate and the second-sized glass substrate to the jig.
